(19) United States
(12) Patent Application Publication
(10) Pub. No.: US 2016/0050699 A1
(43) Pub. Date: Feb. 18, 2016

(54) PAIRING OF BLUETOOTH DEVICES

(71) Applicant: International Business Machines Corporation, Armonk, NY (US)

(72) Inventors: Gregory Jensen Boss, Saginaw, MI (US); Andrew R. Jones, Round Rock, TX (US); Kevin C. McConnell, Austin, TX (US); John Elbert Moore, JR., INDIANAPOLIS, IN (US)

(21) Appl. No.: 14/461,142

(22) Filed: Aug. 15, 2014

(51) Int. Cl. H04W 76/02; H04W 4/02; H04W 12/06; H04L 29/08; H04W 4/00

(52) U.S. Cl. CPC H04W 76/023; H04L 67/12; H04W 4/008; H04W 12/06; H04W 4/021

(57) ABSTRACT

A method includes a computer device receiving at least one vehicle ID of at least one vehicle; the computer device receiving at least one mobile device ID of at least one mobile device; and the computer device conducting two-way authentication between the at least one mobile device and the at least one vehicle using the at least one vehicle ID and the mobile device ID prior to the at least one mobile device being in direct communication with the at least vehicle.

### BACKGROUND

The present invention relates to Bluetooth pairing of devices, and more specifically, to pairing of Bluetooth devices before they are in Bluetooth communication range.

### SUMMARY

According to one aspect of the present invention, a method includes a computer device receiving at least one vehicle ID of at least one vehicle; the computer device receiving at least one mobile device ID of at least one mobile device; and the computer device conducting two-way authentication between the at least one mobile device and the at least one vehicle using the at least one vehicle ID and the mobile device ID prior to the at least one mobile device being in direct communication with the at least vehicle.

According to another aspect of the present invention, a system includes: one or more processors, one or more computer-readable memories and one or more computer-readable, tangible storage devices; a receiving module operatively coupled to at least one of the one or more storage devices for execution by at least one of the one or more processors via at least one of the one or more memories, configured to receive at least one vehicle ID of at least one vehicle; the receiving module operatively coupled to at least one of the one or more storage devices for execution by at least one of the one or more processors via at least one of the one or more memories, configured to receive at least one mobile device ID of at least one mobile device; and an authentication module operatively coupled to at least one of the one or more storage devices for execution by at least one of the one or more processors via at least one of the one or more memories, configured to conduct two-way authentication between the at least one mobile device and the at least one vehicle using the at least one vehicle ID and the mobile device ID prior to the at least one mobile device being in direct communication with the at least vehicle.

According to yet another aspect of the present invention, a computer including: one or more computer-readable, tangible storage medium; program instructions, stored on at least one of the one or more storage medium, to receive at least one vehicle ID of at least one vehicle; program instructions, stored on at least one of the one or more storage medium, to receive at least one mobile device ID of at least one mobile device; and program instructions, stored on at least one of the one or more storage medium, to conduct two-way authentication between the at least one mobile device and the at least one vehicle using the at least one vehicle ID and the mobile device ID prior to the at least one mobile device being in direct communication with the at least vehicle.

### BRIEF DESCRIPTION OF THE SEVERAL VIEWS OF THE DRAWINGS

FIGS. 1A and 1B show exemplary implementations according to embodiments of the present invention.

FIG. 2 shows a flowchart according to an embodiment of the present invention.

FIG. 3 shows another flowchart according to an embodiment of the present invention.

FIG. 4 shows still another flowchart according to an embodiment of the present invention.

FIG. 5 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

Embodiments of the present invention allow for the Bluetooth or wireless (or other type of wire-free connectivity) communication pairing between a rental vehicle (or similar machine) and a customer's smart phone (or other personal communication devices) without the phone and vehicle being in physical communication range.

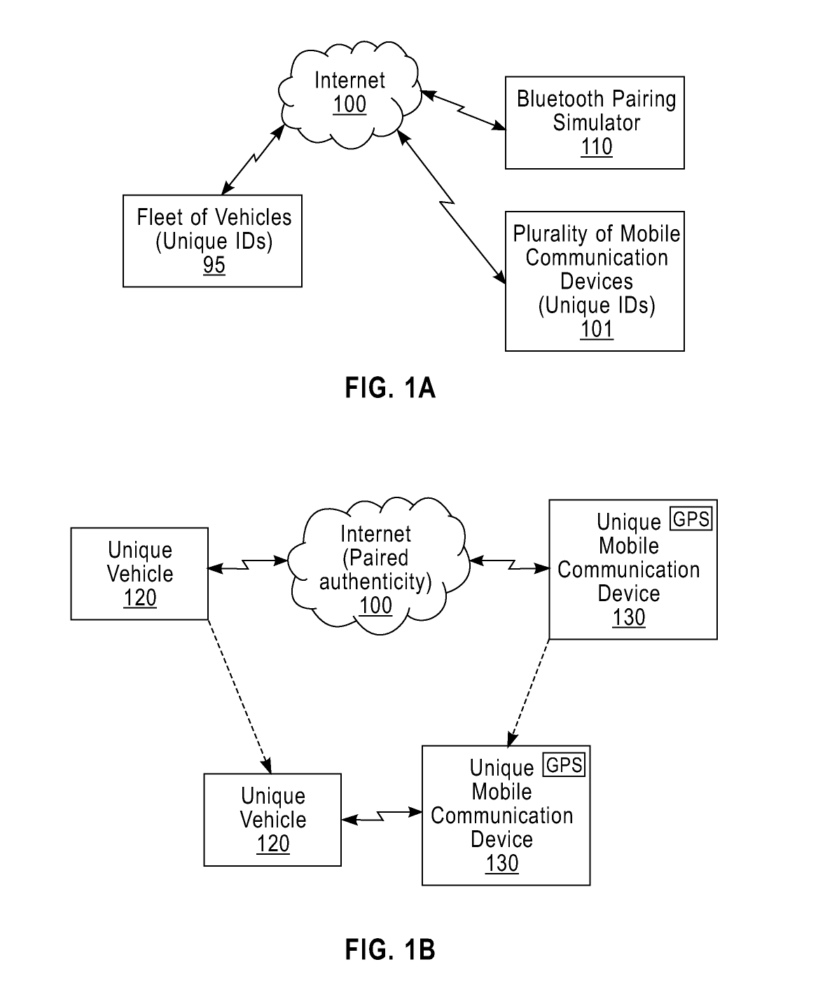

Now referring to FIGS. 1A and 1B, an embodiment of the present invention includes a fleet of vehicles 95 having unique Bluetooth IDs and WiFi (SSIDs and passwords) typically belonging to a rental company. The vehicles are in communications with a Bluetooth pairing simulator 110 via the internet 100. A plurality of mobile communication devices 101 also connected to the internet 100. Each of the plurality of mobile communication devices 101 have a unique Bluetooth ID. A car rental app on the plurality of mobile communication devices 101 allows a person to reserve a rental vehicle from the fleet of vehicles 95. When a user of a unique mobile communication device 130 wants to reserve a unique vehicle 120, the rental app on the unique mobile communication device 130 connects to the Bluetooth pairing simulator 110 via the internet 100. The Bluetooth simulator 110 receives the Bluetooth requirements from an assigned unique vehicle 120. The Bluetooth simulator 110 also receives the Bluetooth requirements from the unique mobile communication device 130 via the car rental app. The Bluetooth simulator 110 conducts a pairing authentication process using the received requirements of the unique mobile communication device 130 and the assigned unique vehicle 120. This allows the unique mobile communication device 130 to be authenticated paired with the unique assigned vehicle 120 via the internet 100. While the unique mobile communication device 130 and the unique assigned vehicle 120 may be Bluetooth paired they are not in physical Bluetooth communication range of each other. The rental app on the unique mobile communication device 130 has access to the GPS functions of the unique mobile communication device 130 and the unique assigned vehicle 120. When the unique mobile communication device 130 is within physical Bluetooth communication range of the unique assigned vehicle 120, the authenticated pairing is handed off from the Bluetooth simulator 110 to the unique mobile communication device 130 and the unique assigned vehicle 120. This allows for a seamless Bluetooth communication connection between the unique mobile communication device 130 and the unique assigned vehicle 120.

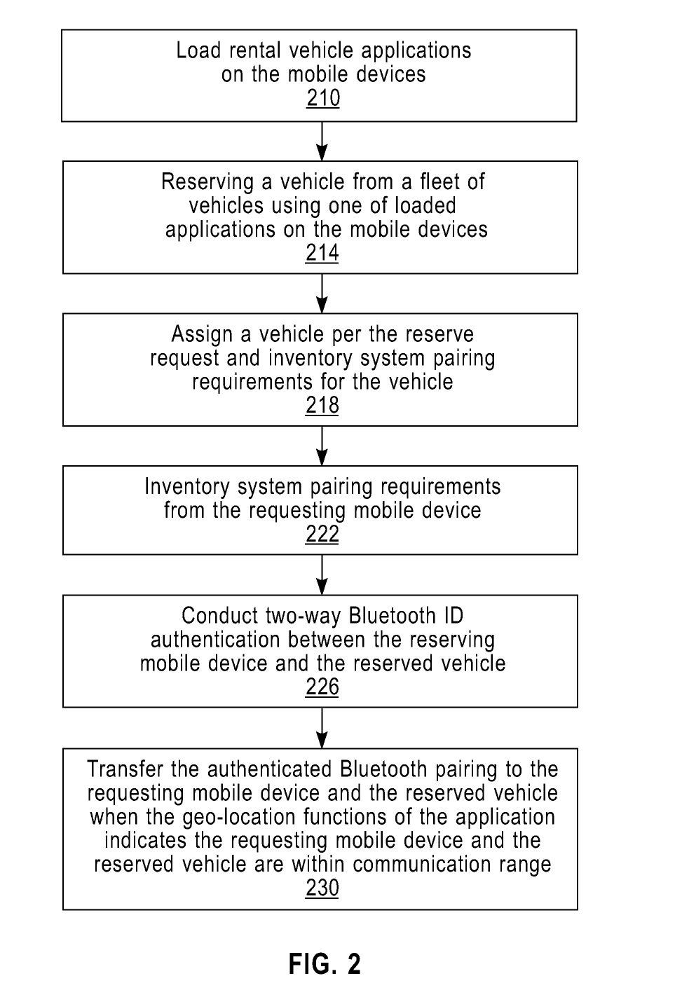

Referring to FIG. 2, a flowchart according to an embodiment of the present invention includes a process for the authenticated pairing between a mobile communication device and a vehicle. The process includes loading rental vehicle applications on mobile devices (210). Using the app, a user reserves a vehicle from a fleet of vehicles from the rental company (214). The rental company smart phone app interrogates the smart phone to obtain it's Bluetooth unique ID. The user must give explicit instructions for the app to be able to do this. The app then sends along an encrypted communication to the Bluetooth simulator to be used to connect to the car. The rental company assigns a vehicle per the reserve request and the process inventories the vehicle's system Bluetooth pairing requirements (218). The process then inventories the system Bluetooth pairing requirements from the requesting mobile device (222). Once the all the Bluetooth pairing requirements have been inventoried, the process conducts two-way Bluetooth ID authentication between the reserving mobile device and the reserved vehicle (226). Finally, the process transfer the authenticated Bluetooth pairing to the requesting mobile device and the reserved vehicle when the geo-location functions of the application indicates the requesting mobile device and the reserved vehicle are within communication range (230). It is noted the process could be modified wherein the Bluetooth ID requirements for the reserved vehicle is sent directly to the mobile app. Then when the geo-location functions of the application indicates the requesting mobile device and the reserved vehicle are within communication range the pairing process is conducted. The pairing process may include triggering the discovery mode for both the requesting mobile device and the reserved vehicle when they are within communication range.

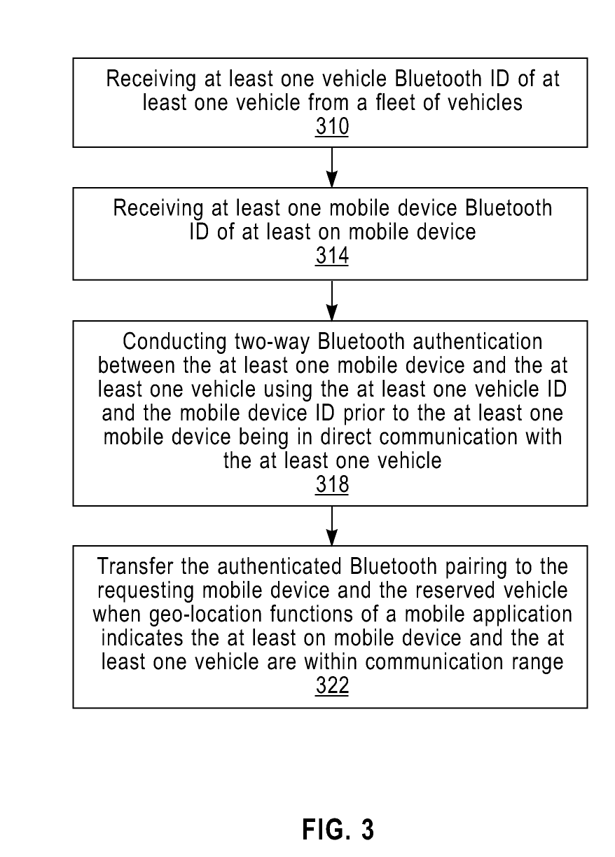

Referring to FIG. 3, a flowchart according to another embodiment of the present invention includes a process for the authenticated pairing between a mobile communication device and a vehicle. The process includes receiving at least one vehicle Bluetooth ID from at least one vehicle from a fleet of vehicles (310). The process further includes receiving at least one mobile device Bluetooth ID of at least one mobile device (314). The process then conducts two-way Bluetooth authentication between the at least one mobile device and the at least one vehicle using the at least one vehicle ID and the mobile device ID prior to the at least one mobile device being in direct communication with the at least vehicle (318). The process finishes by transferring the authenticated Bluetooth pairing to the requesting mobile device and the reserved vehicle when geo-location functions of a mobile application indicates the at least one mobile device and the at least one vehicle are within communication range (322).

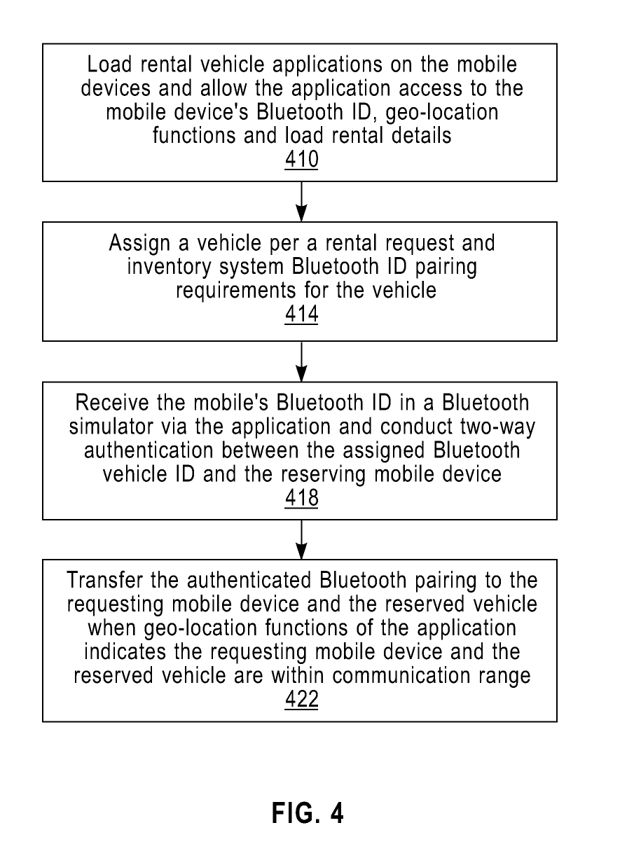

Referring now to FIG. 4, a flowchart according to still anther embodiment of the present invention includes a process for the authenticated pairing between a mobile communication device and a vehicle. This process includes loading rental vehicle applications on mobile devices and allow the application access to the mobile device's Bluetooth ID, geo-location functions and loading the rental details (410). Assigns a vehicle per the reserve request and the process inventories the vehicle's system Bluetooth pairing requirements in a Bluetooth simulator (414). The process then sends the mobile's Bluetooth ID to the Bluetooth simulator via the application. The Bluetooth simulator conducts two-way authentication between the assigned Bluetooth vehicle ID and the reserving mobile device (418). Finally, the process transfers the authenticated Bluetooth pairing to the requesting mobile device and the reserved vehicle when the geo-location functions of the application indicates the requesting mobile device and the reserved vehicle are within communication range (422).

The following describes possible examples for embodiments of the present invention:

### Example 1

1. Driver installs [rental] company application on their smart phone and
   1. enters authentication details for the rental car company account (i.e. user id/password)
   2. authorizes the rental company app to have privileged access to the phones Bluetooth and geo-location functions
2. Driver reserves vehicle
3. Rental car company assigns a vehicle to the renter (and inventory system identifies the equipment in the rental including make, model, type, unique pairing requirements)
4. Rental car company sends the assigned vehicles unique 48-bit Bluetooth ID to the renters app
5. The app is location aware and when the renter gets close to the rental vehicle it
   1. begins to monitor the smart phone's Bluetooth discovery list for the vehicles Bluetooth ID
   2. puts the users phone in device discovery mode (i.e. “inquiry phase” which sends a inquiry request to all devices found within its range)
6. Renter's phone “discovers” vehicles Bluetooth ID (which matches the ID in the rental companies app)
7. The app (having access privileges over Bluetooth functions) automates the pairing and bonding process with the predefined Bluetooth ID and enters the Bluetooth “link key” (aka PIN)
8. The renters phone is now paired with the vehicle with no manual inputs to the renters phone.

### Example 2

1. Driver installs [rental] company application on their smart phone and
   1. enters authentication details for the rental car company account (i.e. user id/password)
   2. the smart phone queries the phones unique 48-bit Bluetooth ID (or equivalent ID for other paired technologies—e.g. WiFi SSID, etc) and devices Service Discovery Protocol (SDP) info
   3. authorizes the rental company app to have access to Bluetooth and geolocation functions
2. Driver reserves vehicle
3. Rental car company assigns a vehicle to the renter (and inventory system identifies the equipment in the rental including make, model, type, unique pairing requirements)
4. Rental car company pulls the renters unique 48-bit Bluetooth ID from the users phone and downloads it to a handheld Bluetooth Pairing simulator
5. Rental car company employee (likely when parking the car) activates the Bluetooth Pairing Simulator and
   1. Bluetooth Pairing Simulator pairs with the vehicle using the SDP info and 48-bit Bluetooth ID
   2. Bluetooth Pairing Simulator stores the “device profile” which includes the link-key and bonding information
6. Rental car company sends the “device profile” for the assigned vehicles to the renters app
7. Rental car company's app transfers the “device profile” to the phones Bluetooth management stack
8. The renters phone is now paired with the vehicle without any manual input and without being anywhere near the vehicle
9. Sometime later . . . renter enters car and turns vehicle on and phone and device automatically pair.

In an alternate embodiment of the present invention, some of the processes are simulated virtually without the need for a physical Bluetooth Pairing Simulator. In this case the Service Discovery Protocol (SDP) info and 48-bit Bluetooth ID for both vehicle and phone will be needed. If all the necessary information is stored in a database then the pairing can be simulated virtually (in a software program or on a server) and the resulting link-key and bonding information can be transferred.

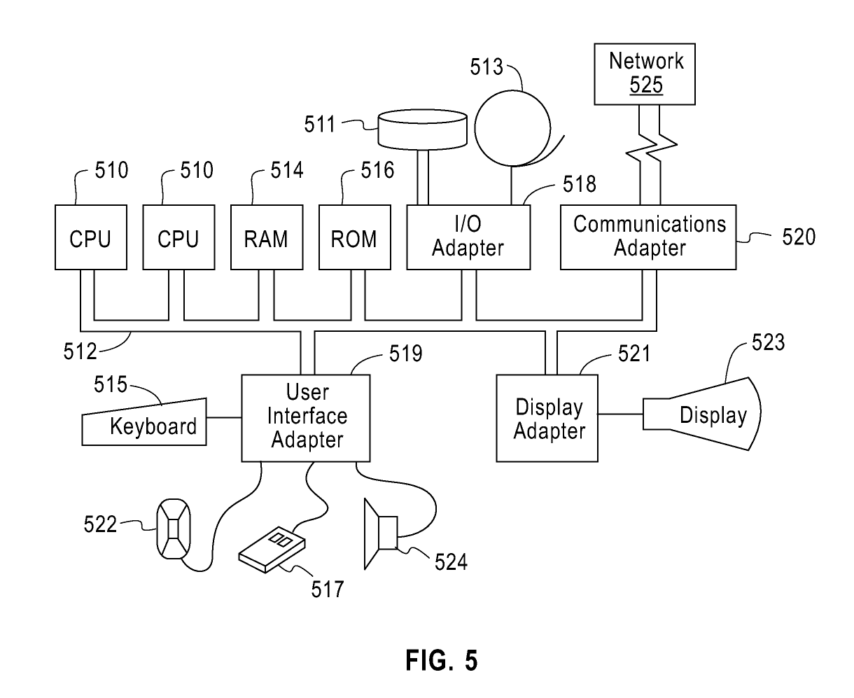

Referring now to FIG. 5, this schematic drawing illustrates a hardware configuration of an information handling/computer imaging system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computer device receiving at least one vehicle ID of at least one vehicle;
the computer device receiving at least one mobile device ID of at least one mobile device; and
the computer device conducting two-way authentication between the at least one mobile device and the at least one vehicle using the at least one vehicle ID and the mobile device ID prior to the at least one mobile device being in direct communication with the at least vehicle.

2. The method according to claim 1, wherein the at least one vehicle ID and the at least one mobile device ID are Bluetooth IDs.

3. The method according to claim 2, wherein the authentication is conducted using the Bluetooth IDs.

4. The method according to claim 1, wherein the computer device uses geo-location functions of the at least one mobile device.

5. The method according to claim 1, wherein the authentication is done remotely from the at least one vehicle and the at least one mobile device.

6. The method according to claim 5, wherein the remote authentication is handled off to the at least one vehicle and the at least one mobile device when the at least one mobile device is within direct communication range of the at least one vehicle.

7. The method according to claim 1, wherein the computer device is a Bluetooth pairing simulator.

8. A system comprising:
one or more processors, one or more computer-readable memories and one or more computer-readable, tangible storage devices;
a receiving module operatively coupled to at least one of the one or more storage devices for execution by at least one of the one or more processors via at least one of the one or more memories, configured to receive at least one vehicle ID of at least one vehicle;
the receiving module operatively coupled to at least one of the one or more storage devices for execution by at least one of the one or more processors via at least one of the one or more memories, configured to receive at least one mobile device ID of at least one mobile device; and
an authentication module operatively coupled to at least one of the one or more storage devices for execution by at least one of the one or more processors via at least one of the one or more memories, configured to conduct two-way authentication between the at least one mobile device and the at least one vehicle using the at least one vehicle ID and the mobile device ID prior to the at least one mobile device being in direct communication with the at least vehicle.

9. The system according to claim 8, wherein the at least one vehicle ID and the at least one mobile device ID are Bluetooth IDs.

10. The system according to claim 9, wherein the authentication is conducted using the Bluetooth IDs.

11. The system according to claim 8, wherein the authentication module uses geo-location functions of the at least one mobile device.

12. The system according to claim 8, wherein the authentication is done remotely from the at least one vehicle and the at least one mobile device.

13. The system according to claim 12, wherein the remote authentication is handled off to the at least one vehicle and the at least one mobile device when the at least one mobile device is within direct communication range of the at least one vehicle.

14. The system according to claim 8, wherein the receiving and authentication modules are part of a Bluetooth pairing simulator.

15. A computer program product comprising:
one or more computer-readable, tangible storage medium;
program instructions, stored on at least one of the one or more storage medium, to receive at least one vehicle ID of at least one vehicle;
program instructions, stored on at least one of the one or more storage medium, to receive at least one mobile device ID of at least one mobile device; and
program instructions, stored on at least one of the one or more storage medium, to conduct two-way authentication between the at least one mobile device and the at least one vehicle using the at least one vehicle ID and the mobile device ID prior to the at least one mobile device being in direct communication with the at least vehicle.

16. The computer program product according to claim 15, wherein the at least one vehicle ID and the at least one mobile device ID are Bluetooth IDs.

17. The computer program product according to claim 16, wherein the authentication is conducted using the Bluetooth IDs.

18. The computer program product according to claim 15, further comprises program instructions, stored on at least one of the one or more storage medium, to use geo-location functions of the at least one mobile device.

19. The computer program product according to claim 15, wherein the authentication is done remotely from the at least one vehicle and the at least one mobile device.

20. The computer program product according to claim 19, wherein the remote authentication is handled off to the at least one vehicle and the at least one mobile device when the at least one mobile device is within direct communication range of the at least one vehicle.
